(19) United States
(12) Patent Application Publication
(10) Pub. No.: US 2025/0192505 A1
(43) Pub. Date: Jun. 12, 2025

(54) COHERENTLY-SPECTRALLY SYNTHESIZED OPTICAL PULSE SHAPING AND AMPLIFICATION

(71) Applicant: The Regents of the University of California, Oakland, CA (US)

(72) Inventors: Tong Zhou, Albany, CA (US); Siyun Chen, Fremont, CA (US); Qiang Du, Pleasanton, CA (US); Dan Wang, Albany, CA (US); Russell Wilcox, Berkeley, CA (US); Cameron Geddes, Berkeley, CA (US)

(21) Appl. No.: 18/977,673

(22) Filed: Dec. 11, 2024

Related U.S. Application Data
(60) Provisional application No. 63/608,875, filed on Dec. 12, 2023.

(51) Int. Cl. H01S 3/10; H01S 3/00

(52) U.S. Cl. CPC H01S 3/10015; H01S 3/0057; H01S 3/10053

(57) ABSTRACT

This disclosure provides systems, devices, apparatus, and methods, for generating a pulse-shaped and spectrally-combined optical pulse. The method includes spectrally splitting an optical pulse into a plurality of portions in a plurality of channels. The method includes that, for at least one portion of the plurality of portions, shaping a spectral intensity and a spectral phase of each of the at least one portion in each of at least one channel of the plurality of channels to generate at least one pulse-shaped portion of a plurality of pulse-shaped portions. The method further includes spectrally recombining the plurality of pulse-shaped portions in the plurality of channels to generate the pulse-shaped and spectrally-combined optical pulse.

### CROSS REFERENCE TO RELATED APPLICATION(S)

This application claims the benefit of and priority to U.S. Provisional Application Ser. No. 63/608,875, entitled “Coherently-spectrally synthesized optical pulse shaping and amplification” and filed on Dec. 12, 2023, the disclosure of which is incorporated herein by reference in its entirety.

### STATEMENT OF GOVERNMENT RIGHTS

This invention was made with government support under Contract No. DE-AC02-05CH11231 awarded by the U.S. Department of Energy. The government has certain rights in the invention.

### TECHNICAL FIELD

The present disclosure relates generally to laser systems, and more particularly, to systems and methods of coherently-spectrally synthesized optical pulse shaping and amplification.

### BACKGROUND

Digital programmable optical pulse shapers based on spatial light modulators have been commercialized to provide high resolution, programmable spectral intensity and phase controls for broadband optical pulses. One important application of these pulse shapers are spectral intensity and phase controls for generating ultrashort pulses in laser amplifier systems. Current commercial high-resolution, programmable pulse shapers, however, have limited passbands less than about tens of nanometer, limiting the bandwidth of high-resolution spectral intensity and phase controls.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A illustrates a diagram of an example of a two-channel spectrally-combined laser system according to some embodiments.

FIG. 1B illustrates a diagram of an example of transmission spectrum of a dichroic mirror in the laser system in FIG. 1A according to some embodiments.

FIG. 2A illustrate an example of measured spectrum before splitting, and spectrum of each channel without pulse shaping of the laser system in FIG. 1A according to some embodiments.

FIG. 2B illustrate a zoomed-in view of channel 2 spectrum in FIG. 2A according to some embodiments.

FIG. 2C illustrate an example of measured spectra after the dichroic combiner with pulse shaping of the laser system in FIG. 1A according to some embodiments.

FIG. 2D illustrate an example of measured autocorrelation traces of the pulse from each channel after compression, and of the combined and compressed pulse, in comparison with the calculated autocorrelation trace of the transform-limited pulse for the combined spectrum in FIG. 2C according to some embodiments.

FIG. 3A illustrates a diagram of an example of a three-channel spectrally-combined laser system according to some embodiments.

FIG. 3B illustrates a diagram of an example of transmission spectrum of a dichroic mirror in the laser system in FIG. 3A according to some embodiments.

FIG. 3C illustrates a diagram of another example of transmission spectrum of a dichroic mirror in the laser system in FIG. 3A according to some embodiments.

FIG. 4 illustrates a free-running power spectrum (1-1000 Hz) of the leakage port of the combiner combining Channel 1 and 2 in FIG. 3A.

FIG. 5A illustrates an example of measured spectra after combiners of the laser system in FIG. 3A according to some embodiments.

FIG. 5B illustrates an example of measured autocorrelation traces after compression (combined pulse, and pulse from each channel), and calculated autocorrelation trace of the transform-limited pulse for the combined spectrum in FIG. 5A.

FIG. 6A illustrates an example of spectral phase profiles of the pulse shapers in the laser system in FIG. 3A according to some embodiments.

FIG. 6B illustrates an example of spectral attenuation profiles of the pulse shapers in the laser system in FIG. 3A according to some embodiments.

FIG. 7 illustrates an example of simulation of output energy and gain for different wavelengths according to some embodiments.

FIG. 8 illustrates a diagram of an example of a multi-channel spectrally-combined optical system according to some embodiments.

FIG. 9 illustrates a flow diagram of a method of generating a pulse-shaped and spectrally-combined laser pulse according to some embodiments.

### DETAILED DESCRIPTION

Details of one or more embodiments of the subject matter described in this specification are set forth in the accompanying drawings and the description below. Other features, aspects, and advantages will become apparent from the description, the drawings, and the claims. Note that the relative dimensions of the figures may not be drawn to scale.

Yb-based laser systems have a broad range of applications in science, industry, security, and medicine. In particular, Yb-doped fiber laser systems are able to deliver high power, ultrashort pulses, which is important for many applications. Some applications of high-energy, ultrashort optical pulses also require high repetition rate, resulting in high average power. For example, the next-generation laser-plasma accelerators require unprecedented laser performance, at up to multi-Joule pulse energy, tens-offs pulse duration, and up to 300 kW average power. Fiber lasers are capable of very high average power and wall-plug efficiency, and with spatial beam combining and temporal pulse stacking can generate high energy for demanding applications.

As the popular high power gain medium in fiber silica glass, Yb ions have a broad gain spectrum >80 nm, fundamentally compatible with pulses <40 fs. However, in high-energy fiber chirped-pulse amplification (FCPA) systems where total amplification gain can reach 100 dB, the non-flat emission cross section profile of Yb ions leads to gain narrowing that limits the amplified spectral bandwidth to <6 nm FWHM (>300 fs). The shortest pulse duration demonstrated with mJ-level pulse energy in a Yb-doped FCPA channel was around 120-130 fs, with spectral intensity and phase shaping to overcome gain narrowing and high order dispersion. Thus, it is difficult to achieve about 40 fs pulse duration for broad applications.

Nonlinear pulse compression using spectral broadening in a nonlinear medium and subsequent compression has been rapidly developed as a post-laser short-pulse approach. However, the achievable peak power was limited to around a terawatt, due to ionization in gas-filled hollow-core fibers and multi-pass cavities, or self-focusing in solids (standalone, cascaded, or in-cavity). The compressed, usable energies are limited to tens of mJ for tens of fs pulses, and a few mJ for few-cycle pulses. Besides energy limitations, unwanted compressed pulse pedestals resulting from mismatched nonlinear chirp is a challenge for prepulse-sensitive applications including plasma acceleration.

On the other hand, combining multiple spectra may be used to generate ultrashort pulses. Spectral combining in FCPA systems to overcome gain narrowing was demonstrated with three spectral channels in a Yb fiber system and a combined pulse duration of 403 fs. Later on shorter pulses were demonstrated from spectrally combined FCPA systems, and 97 fs pulse duration at one-micron wavelength with 10 μJ pulse energy was achieved from a two-channel system. Further advances toward shorter pulses from broadband, spectrally-combined FCPA systems are also hindered by high order dispersion mismatches besides broadband gain distortions. Multi-stage FCPA systems usually have a total fiber length of 50-100 m, resulting in significant higher order dispersion mismatches with the stretcher and compressor, which broaden and distort the final compressed pulse. In high energy systems, nonlinear spectral phases on chirped pulses also contribute to temporal pulse broadening, since they also result in higher order spectral phase mismatches. It has increased complexity to generate ultrashort pulses for many applications.

Aspects of the present disclosure address the above-noted and other deficiencies by coherent spectral synthesis of multiple pulse shapers in a multi-channel, spectrally-combined system. In some examples, a multi-channel spectrally-combined fiber laser system includes multiple pulse shapers operating at different but partially-overlapped spectrum in each channel to control the spectral intensity and phase. Coherent synthesis of the multiple shapers is achieved by phase-synchronizing the multiple channels at the overlapped spectrum. Adding amplifiers in each spectral channel (associated spectral intensity and phase distortions are compensable using in-channel pulse shapers) and incorporating more spectral channels may provide a high energy, tens-of-fs fiber laser system.

In some examples, ultra-broadband spectral combining in FCPA systems can achieve about 40 fs pulse duration, while maintaining the ability to precisely control the spectral intensity and phase over the broad spectrum. These results demonstrate principles that can be scaled to higher energy and average power laser systems. In some examples, coherent spectral combining in spatiotemporal combination FCPA systems may provide an energy-scalable, short-pulse method for demanding applications including plasma acceleration (up to multi-J pulse energy with ˜40 fs duration). In such systems, each spectral channel has a spatially combined fiber amplifier array, and spectral combining comes after spatial combining and before temporal pulse stacking.

To enable spectral combining in the tens-of-fs pulse duration regime, programmable, broad-band pulse shaping that can provide precision, tunable spectral intensity and phase control is used to compensate for gain narrowing, high order dispersion mismatches, and nonlinear phases. These effects become more severe with broader bandwidth. Digital programmable pulse shapers based on spatial light modulators are particularly attractive for such applications, and offer great advantages on programmability, stability, reliability, and compactness. While current commercial versions have limited passbands less than tens of nm, multiple pulse shapers may be coherently-spectrally synthesized in broadband spectral combining systems.

Described herein are systems and methods of coherently-spectrally synthesized optical pulse shaping and amplification, which can coherently-spectrally synthesize multiple pulse shapers to achieve broadband high-resolution pulse shaping (e.g., spectral intensity and phase programming). The combination of multiple pulse-shaped, distinct but slightly overlapped spectra needs precision phase synchronization at the overlapping spectral ranges to achieve coherent spectral synthesis.

In ultrashort-pulse laser amplifier systems, embodiments described herein can realize full control of spectral intensity and phase in very broad spectral ranges, so that the inherent spectral intensity and phase limits associated with broad laser bandwidth and high amplification gain can be overcome and ultrashort amplified laser pulses can be generated. Embodiments described herein are applicable to a range of applications in which broadband precision optical pulse shaping or high power ultrashort laser pulses are needed.

According to some aspects, a method of generating a spectrally-combined optical pulse is disclosed. The method includes spectrally splitting an optical pulse into a plurality of portions in a plurality of channels. The method includes that, for at least one portion of the plurality of portions, shaping a spectral intensity and a spectral phase of each of the at least one portion in each of at least one channel of the plurality of channels to generate at least one pulse-shaped portion of a plurality of pulse-shaped portions. The method further includes spectrally recombining the plurality of pulse-shaped portions in the plurality of channels to generate the spectrally-combined optical pulse.

According to some aspects, a system includes at least one splitter to spectrally split an optical pulse into a plurality of portions in a plurality of channels. The system includes a plurality of pulse shapers operatively coupled with the at least one splitter, each pulse shaper of the plurality of pulse shapers to shape a spectral intensity and a spectral phase of each of at least one portion of the plurality of portions in each of at least one channel of the plurality of channels to generate at least one pulse-shaped portion of a plurality of pulse-shaped portions. The system further includes at least one combiner to spectrally recombine the plurality of pulse-shaped portions in the plurality of channels to generate a spectrally-combined optical pulse.

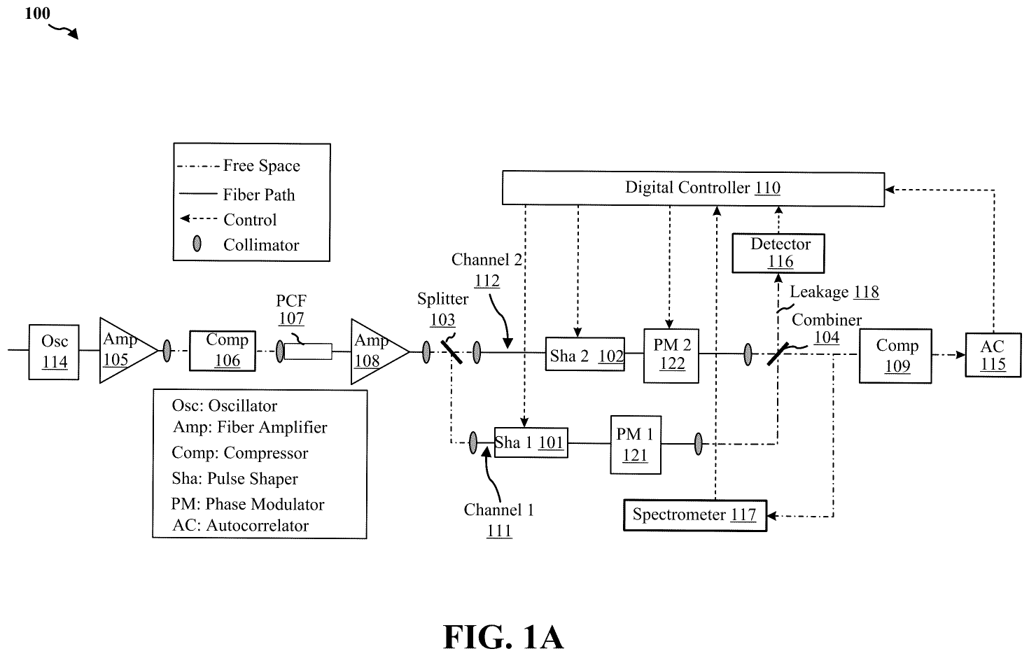

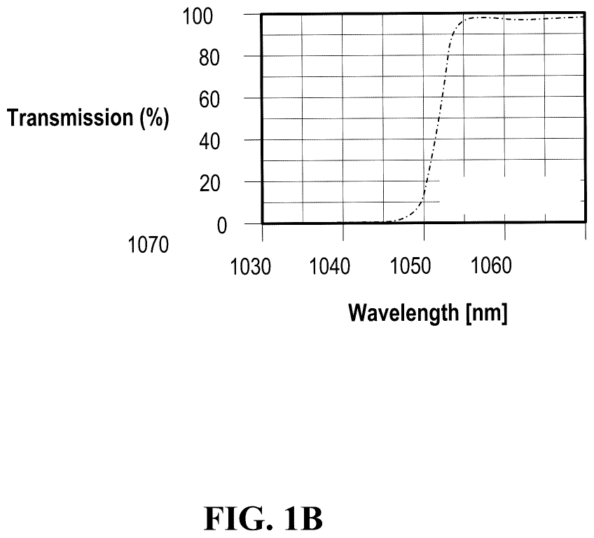

FIG. 1A illustrates a diagram of an example of a two-channel spectrally-combined laser system 100 according to some embodiments. The laser system 100 includes a splitter 103, e.g., a dichroic mirror, to split a laser pulse into two portions in two channels, channel 1 111 and channel 2 112. The laser system 100 includes two pulse shapers, a pulse shaper 1 101 and a pulse shaper 2 102, operatively coupled with the splitter 103. Each pulse shaper is configured to shape a spectral intensity and a phase of a portion of the laser beam in a channel of the two channels to generate at a pulse-shaped portion of two pulse-shaped portions. The laser system 100 further includes a combiner 104 to spectrally recombine the two pulse-shaped portions in the two channels to generate a spectrally-combined laser pulse.

The laser system 100 includes the two pulse shapers (e.g., the pulse shaper 1 101, the pulse shaper 2 102) operating at different but partially-overlapped spectrum in each channel to control the spectral intensity and phase. Bandwidths of the two channels 111, 112 may overlap in a range from 0.5 nm to 10 nm. As an example, a bandwidth of the channel 1 111 and a bandwidth of the channel 2 112 may have an overlapped spectrum which is about 1 nm. Coherent synthesis of the two shapers is achieved by phase-synchronizing the two channels (e.g., 111, 112) at the overlapped spectrum. At least two pulse shapers may be used since high-resolution, spatial-light-modulator-based pulse shapers have limited passbands that are less than tens of nm, e.g., a maximum passband of about 50 nm (1015-1065 nm, and 1045-1095 nm). The laser system 100 may generate combined pulses with pulse durations which are compressed to 54 fs.

Referring to FIG. 1A, a laser source, such as an oscillator 114, e.g., a mode-locked oscillator, may generate laser pulses, e.g., 120 fs laser pulses at 1040 nm center wavelength with 100 MHz repetition rate. The laser pulses may be amplified in an amplifier 105 (e.g., a Yb-doped fiber amplifier (YDFA)), and recompressed by a compressor 106 (e.g., a grating compressor). Then, the laser pulses may be directed to a photonic-crystal fiber (PCF) 107, where the spectrum is broadened from 27 nm to 80 nm (edge-to-edge). The spectral-broaden pulses may be amplified by another amplifier 108 (e.g., YDFA).

Then, the spectral-broaden pulses are spectrally split by the splitter 103, e.g., the dichroic mirror which has a transmission spectrum with a cutoff wavelength at 1052 nm. An example of transmission spectrum of the dichroic mirror is illustrated in FIG. 1B. The splitter 103 may be configured to split the laser pulses into two portions, a first portion with the wavelength below 1052 nm being reflected and directed to the channel 1 111, and a second portion with the wavelength above 1052 nm being transmitted to the channel 2 112. After splitting, the laser pulses in each fiber channel are sent to a respective pulse shaper (e.g., the pulse shaper 101, or 102), which shapes the spectral intensity and phase over the pulse spectrum in each channel. The combiner 104, e.g., an identical dichroic mirror as the spectral splitter, recombines the two pulse-shaped spectra. The combined pulse may be compressed by a grating compressor 109 and diagnosed by an autocorrelator 115. The autocorrelator 115 may be replaced by another temporal pulse diagnostic device. The durations of the chirped pulses from the two fiber channels may be 17 ps and 13.5 ps at the dichroic combiner 104. The spectrum of the combined pulse may be obtained by the spectrometer 117.

The laser system 100 may further include two phase modulators, a phase modulator 1 121 and a phase modulator 2 122. Each phase modulator (e.g., 121 or 122), e.g., a fiber phase modulator, may be disposed after a respective pulse shaper (e.g., 101, or 102) in each fiber channel. The phase modulator 2 122 and/or the phase modulator 1 121 may receive a signal, by using a detector 116, from a phase synchronization feedback loop and compensate for a phase difference between the two channels. The phase synchronization feedback loop may diagnose, detect or receive, the leakage signal 118 from the combiner 104 (e.g., the dichroic combiner) operatively connected with a digital controller 110. The laser system 100 may further include the digital controller 110, which is configured to phase-synchronize the two fiber channels at an overlapped spectrum with a stochastic parallel gradient descent (SPGD) algorithm. As illustrated in FIG. 1A, the digital controller 110 may be configured to receive input signals from the detector 116, the autocorrelator 115, and the spectrometer 117, and control the pulse shaper 1 101, the pulse shaper 2 102, and the phase modulator 2 122. The autocorrelator 115 may be replaced by another temporal pulse diagnostic device.

The laser system 100 may further include a pulse-shaping feedback system, which may diagnose, detect, or receive, the combined spectrum and the autocorrelation signal (or signal from another temporal pulse diagnostic device) of the combined pulse and sends control signals to the pulse shapers (e.g., 101, 102) in each fiber channel accordingly. The pulse-shaping feedback system is configured to compensate for spectral intensity distortions from amplification, and for residual spectral phases in various orders at the system output, thus yielding a smooth combined spectrum with a flat spectral phase.

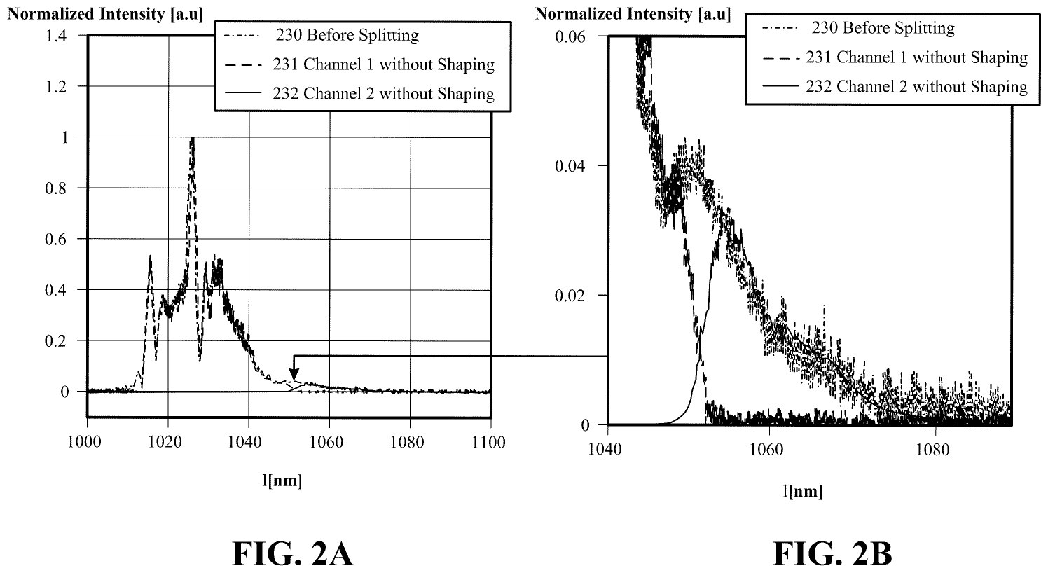

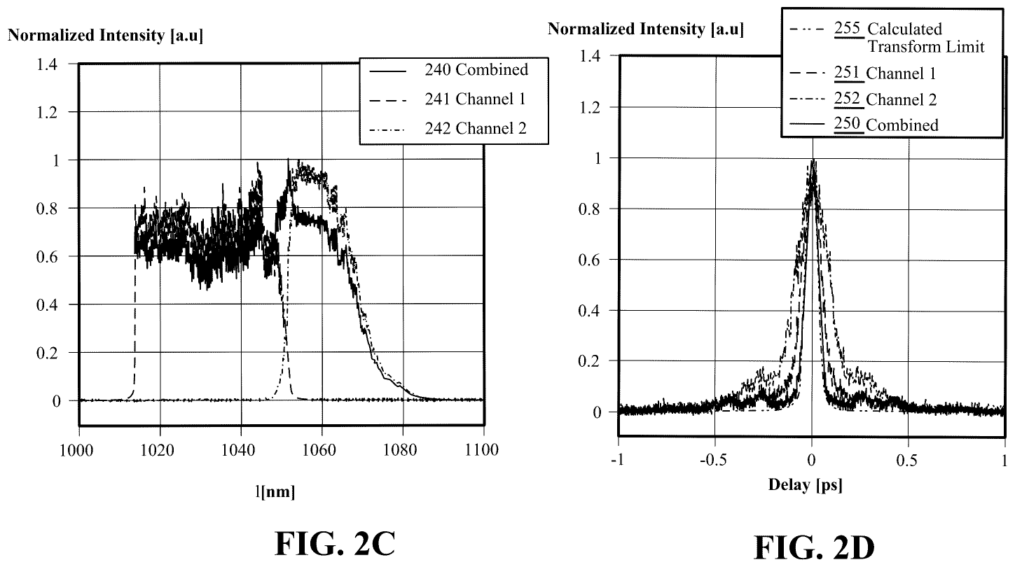

FIG. 2A illustrate an example of measured spectrum before splitting, and spectrum of each channel without pulse shaping of the laser system 100 according to some embodiments. Referring to FIG. 2A, the PCF 107 broadened and amplified spectrum before spectral splitting 230 is illustrated, along with the spectrum 231 of the channel 1 111 without pulse shaping and the spectrum 232 of the channel 2 112 without pulse shaping. A zoomed-in view of the spectrum 232 of the channel 2 112 is shown in FIG. 2B.

FIG. 2C illustrate an example of measured spectra after the dichroic combiner with pulse shaping of the laser system 100 according to some embodiments. The shaped and recombined spectrum 240 is shown in FIG. 2C, which also shows the output shaped spectrum 241 from channel 1 111 and the output shaped spectrum 242 from channel 2 112. While the programmable pulse shapers allow to optimally shape the spectrum intensity for best temporal pulse shape, a close-to-flat-top target combined spectrum is used as an example. In this example, the overlapped spectrum portions from the two fiber channels are interferometric and are in the range of 1047-1054 nm, as shown in FIG. 2C. The power of the shaped pulses before the dichroic combiner are 0.69 mW and 0.4 mW for channel 1 111 and channel 2 112, and the power of the combined pulses is 1.03 mW when the two spectral channels are phase synchronized at the overlapped spectrum, with a combining efficiency of 94.5%.

FIG. 2D illustrate an example of measured autocorrelation traces of the pulse from each channel after compression, and of the combined and compressed pulse, in comparison with the calculated autocorrelation trace of the transform-limited pulse for the combined spectrum in FIG. 2C according to some embodiments. Programmable pulse shapers also result in a nearly flat spectral phase of the spectrum corresponding to each fiber channel, essential to achieving combined pulse duration that is close to the transform limit. The measured autocorrelation trace of the combined and compressed pulse 250 is shown in FIG. 2D, with an FWHM of 78 fs, corresponding to an FWHM pulse duration of 54 fs. The calculated autocorrelation trace of the transform-limited pulse 255 for the combined spectrum in FIG. 2C is also shown in FIG. 2D, with an FWHM of 72 fs, corresponding to an FWHM pulse duration of 50 fs. FIG. 2D also includes the autocorrelation trace of the shaped pulse 251 from channel 1 111 after compression and the autocorrelation trace of the shaped pulse 252 from channel 2 112 after compression, measured at 121 fs and 190 fs (FWHM), corresponding to FWHM pulse durations of 84 fs and 122 fs. Thus, the combined and compressed pulse (54 fs) is significantly shorter than the shaped pulses from each spectral channel after compression, and is close to the transform limit (50 fs) for the shaped and combined spectrum. The deviation of the combined and compressed pulse shape from the transform limit is due to various system mismatches including mismatched beam profiles upon combining, imperfect spectral phases in various orders, residual spatial and temporal-delay misalignments of the two channel outputs, thus can be minimized with further system optimization.

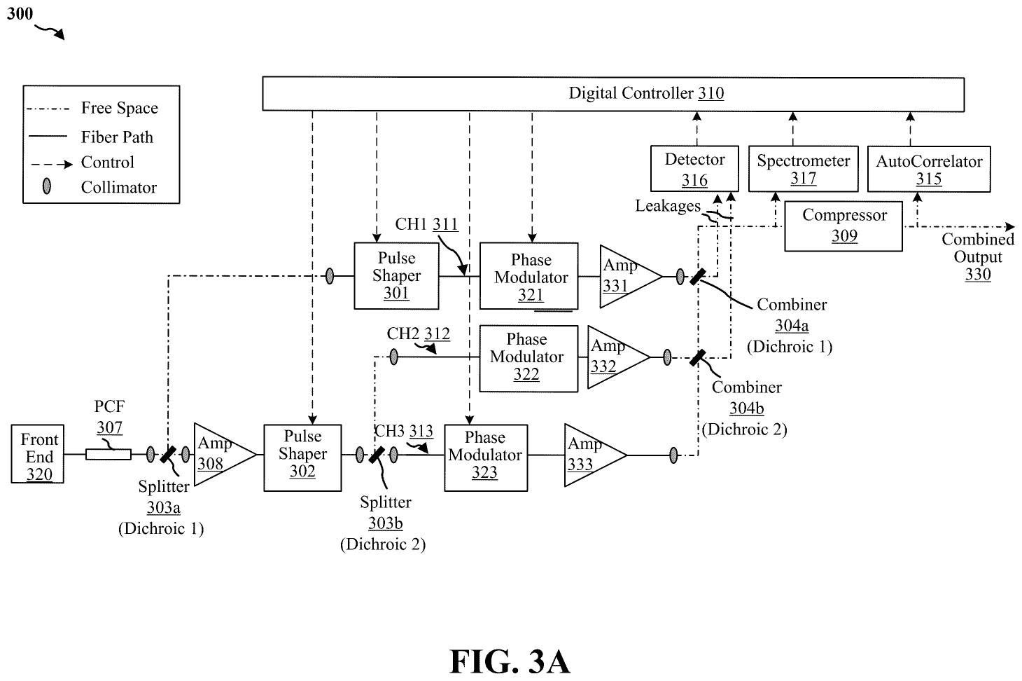

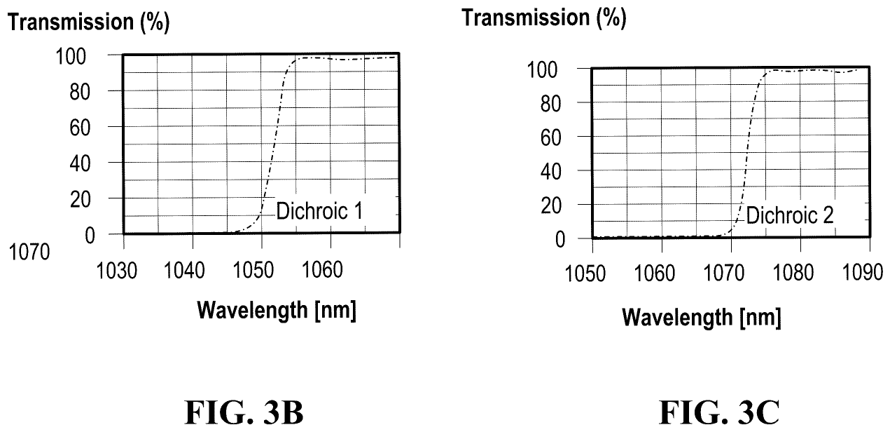

FIG. 3A illustrates a diagram of an example of a three-channel spectrally-combined laser system 300 according to some embodiments. The laser system 300 includes two splitters, a first splitter 303a and a second splitter 303b, to split a laser pulse into three portions in three channels, channel 1 311, channel 2 312, and channel 3 313. The laser system 300 includes two pulse shapers, a first pulse shaper 301 and a second pulse shaper 302, operatively coupled with the splitters 103a, 303b. The first pulse shaper 301 is configured to shape a spectral intensity and a phase of a portion of the laser beam in the channel 1 311 to generate at a pulse-shaped portion of three pulse-shaped portions of a spectrally-combined laser pulse. The second pulse shaper 302 is configured to shape a spectral intensity and a phase of each of two portions of the laser beam in two channels, the channel 2 312 and the channel 3 313, to generate two pulse-shaped portions of the three pulse-shaped portions of the spectrally-combined laser pulse. One difference between the laser system 300 and the laser system 100 is that the second pulse shaper 302 shapes two portions of the laser beam in two channels to generate two pulse-shaped portions in the laser system 300, instead of only shaping one portions of the laser beam in one channel to generate one pulse-shaped portion in the laser system 100. The laser system 300 further includes two combiners, a first combiner 304a and a second combiner 304b, to spectrally recombine the three pulse-shaped portions in the three channels to generate the spectrally-combined laser pulse 330.

By spectrally synthesizing the three channels and two programmable pulse shapers operating at different but partially-overlapped spectra to cover all the three spectral channels, the laser system 300 generates ultrashort pulses. As an example, the pulses have a pulse duration of 42 fs. After the spectral channels with pulse shaping and amplification are phase-synchronized, spectral intensity and phase control over the broad Yb: fiber gain spectrum can be achieved. To the best of our knowledge, 42 fs is the shortest pulse duration from a spectrally combined fiber system at one-micron wavelength. This system and method may provide high-energy, tens-of-fs laser pulses, e.g. implementing broadband spectral combining in spatially-temporally combined FCPA systems, in which case more system optimizations (temporal and spectral) may be used to precisely and algorithmically compensate for different mismatches.

Referring to FIG. 3A, in the front end 320, 120 fs laser pulses at 1040 nm center wavelength with 100 MHz repetition rate are generated, for example, from a mode-locked oscillator, amplified in a Yb-doped fiber amplifier (YDFA), and recompressed by a grating compressor before being sent to a photonic-crystal fiber (PCF) 307 where the spectrum is broadened from 27 nm to 90 nm (edge-to-edge). The broadened pulses are spectrally split by the first splitter 303a, e.g., dichroic mirror 1 with a cutoff wavelength at 1052 nm. The transmission spectrum of the dichroic mirror 1 is illustrated in FIG. 3B. Then, the broadened pulses are sent to the two pulse shapers 301, 302 that shape the intensity and phase of the respective pulse spectrum. As an example, the pulses reflected from the first splitter 303a, e.g., dichroic mirror 1, are sent to the first pulse shaper 301 in channel 1 311. The transmitted pulses are amplified by an amplifier 308, e.g., YDFA, then pulse-shaped by the second pulse shaper 302. Then, the transmitted pulses are further split by the second splitter 303b (e.g., a dichroic mirror 2 with a 1072 nm cutoff wavelength) and coupled to the channel 2 312 and the channel 3 313. The transmission spectrum of the dichroic mirror 2 is illustrated in FIG. 3C. Each spectral channel (channel 1 311, channel 2 312, or channel 3 313) may incorporates a phase modulator and an amplifier (e.g., YDFA). The channel 1 311 may incorporate a fiber phase modulator 321 and an amplifier 331. The channel 2 312 may incorporate a fiber phase modulator 322 and an amplifier 332. The channel 3 313 may incorporate a fiber phase modulator 323 and an amplifier 333. In this way, three pulse-shaped and amplified spectra are generated in the three fiber channels. Afterwards, the combiners 304a, 304b, e.g., dichroic mirrors (identical to the spectral splitters), recombine the three pulse-shaped and amplified spectra from the three fiber channels. The combined pulse may be compressed by a grating compressor 309 and diagnosed or detected by an autocorrelator 315. The autocorrelator 315 may be replaced by another temporal pulse diagnostic device.

The splitters 303a, 303b and the combiners 304a, 304b, e.g., dichroic mirrors, are chosen to have a transition edge of a few nm, so that the overlapped spectra at the leakage ports of the dichroic combiners can be diagnosed or detected for phase synchronization of the spectral channels, while maintaining low spectral combining loss. The fiber phase modulator 321 in the channel 1 311 and the fiber phase modulator 323 in the channel 3 313 receive signals, via a detector 316, from one or more phase synchronization feedback loops and compensate for a phase difference between the two channels. The one or more phase synchronization feedback loops diagnose or detect the leakage signal power from the two combiners 304a, 304b and phase-synchronize the three fiber channels at the overlapped spectral regions with a Stochastic Parallel Gradient Descent (SPGD) algorithm. At the leakage port of each combiner, the overlapped spectra from two spectral channels are interferometric, and the SPGD algorithm minimizes the power there (destructive interference) so that the power at the combined output port is maximized and the combined spectra are in phase, to achieve the shortest combined and compressed pulse. The laser system 300 may further include a digital controller 310, which is configured to phase-synchronize the three fiber channels at overlapped spectra with the SPGD algorithm. As illustrated in FIG. 3A, the digital controller 310 may be configured to receive input signals from the detector 316, the autocorrelator 315 and the spectrometer 317, and control the pulse shaper 301, the pulse shaper 302, the phase modulator 321 and the phase modulator 323. The autocorrelator 315 may be replaced by another temporal pulse diagnostic device.

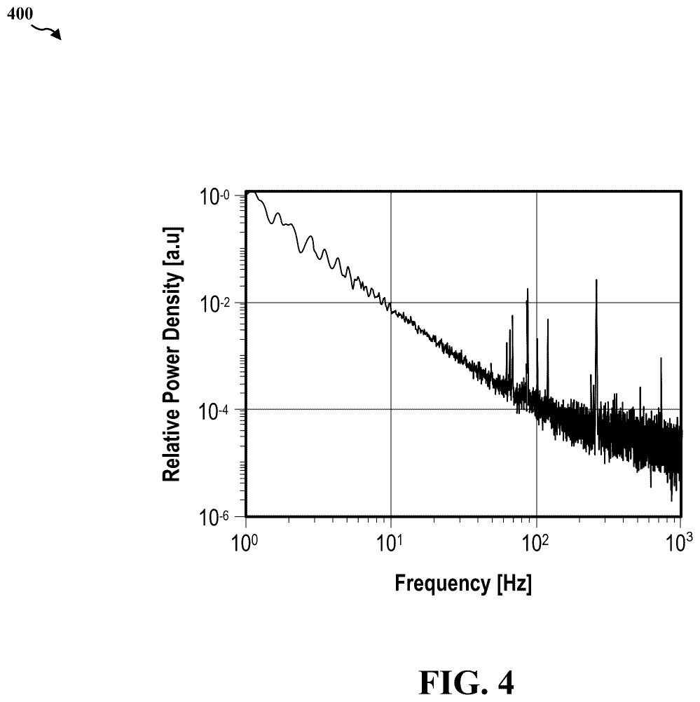

FIG. 4 illustrates an example of a free-running power spectrum (1-1000 Hz) 400 of the leakage port of the combiner 304a combining the channel 1 311 and the channel 2 312. The relative noise power density decreases to <10-2 at 10 Hz and most noise peaks are below few hundreds of Hz. The phase synchronization feedback loops are based on Field Programmable Gate Arrays (FPGA) and the overall feedback bandwidth is multiple kHz. The phase locking of the channel 1 311 and the channel 2 312 has an RMS instability measured to be 0.89% (30 s data, 6.25 kHz sampling), primarily contributed by the combining process with imperfect phase locking. The combination of the channel 2 312 and the channel 3 313 uses a separate, identical feedback loop. In both cases, the channel 2 is the phase reference.

Another pulse-shaping feedback system may diagnose or detect the combined spectrum and the autocorrelation signal (or signal from another temporal pulse diagnostic device) of the combined and compressed pulse and sends control signals to the two pulse shapers accordingly. This is to compensate for spectral intensity distortions from amplification, and for various orders of residual spectral phase at the system output, thus yielding a distortion-free combined spectrum and near transform-limited compressed pulse width.

To achieve high resolution pulse shaping, a wavelength calibration may be performed between the spectrometer 317 and the two pulse shapers 301, 302, using sharp-edge test functions of spectral attenuation, after which the three instruments (the spectrometer 317 and the two pulse shapers) can be operated based on the same wavelength reference. As an example, two pulse shapers may be used to cover the full bandwidth (1015-1095 nm). As another example, three shapers may be used, one for each spectral channel.

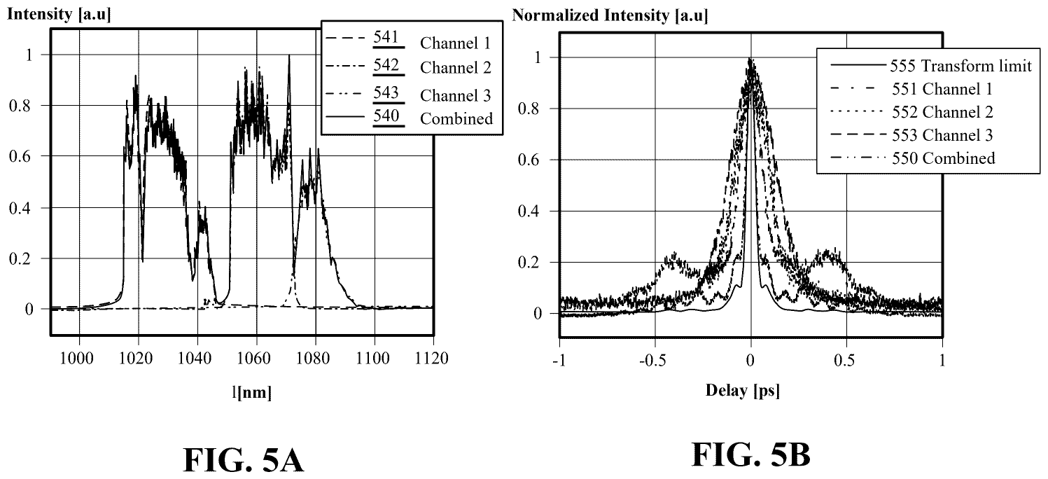

FIG. 5A illustrate an example of measured spectra after the combiners 304a, 304b of the laser system 300 according to some embodiments. Referring to FIG. 5A, the shaped, amplified, and recombined spectrum 540 measured after the combiners 304a, 304b is shown, and the output spectrum from each spectral fiber channel (the output spectrum 541 for the channel 1 311, the output spectrum 542 for the channel 2 312, and the output spectrum 543 for the channel 3 313) is also shown. In this example, the programmable pulse shapers (301, 302) compensate for most of the spectral intensity distortions from broadening and amplification, except for some spectral gaps resulting from the initial nonlinear broadening process in the PCF, which may not be optimized. The two overlapped spectral regions from the three fiber channels are in the range of 1047-1054 nm and 1069-1076 nm, as shown in FIG. 5A. The average spectral combining efficiency, dividing the combined signal power (with all spectral channels phase synchronized) by the total power of the output signals from all three spectral channels before spectral combination, is measured to be 93.6%.

FIG. 5B illustrate an example of measured autocorrelation traces after compression (combined pulse, and pulse from each channel), and calculated autocorrelation trace of the transform-limited pulse for the combined spectrum in FIG. 5A. After the spectral intensity and phase shaping are optimized, and the phases of the three spectral channels 311, 312, 313 are synchronized, the combined and compressed pulse 550 is diagnosed or detected, with autocorrelation shown in FIG. 5B. The calculated autocorrelation trace of the transform-limited pulse 555 for the combined spectrum is shown in FIG. 5B.

The combined pulse energy in this example is not high enough to yield an accurate and stable FROG measurement, but sufficient for autocorrelator diagnostics. In order to retrieve a meaningful pulse duration, the transform-limited pulse 555 is calculated based on the measured combined spectrum in FIG. 5A with the assumption of a flat spectral phase, whose FWHM pulse duration is 38 fs. Then, the autocorrelation trace of the transform-limited pulse is calculated, as shown in FIG. 5B with an FWHM duration of 52 fs, corresponding to a deconvolution factor of 1.37. This factor is applied to the measured autocorrelation of the combined and compressed pulse (58 fs FWHM), to retrieve the combined and compressed pulse duration, calculated to be 42 fs FWHM. This calculation is only valid if the measured autocorrelation duration is close to its transform-limited counterpart, which is the case here (˜10% deviation). Nevertheless, there is a clear mismatch between the wings of the autocorrelation traces for the measured and transform-limited pulses. This may be mainly due to the factors below. First, currently the spectral phase optimization only uses the autocorrelation FWHM duration as the figure of merit, while minimizing pulse pedestals has not yet been implemented. Second, the aforementioned pulse shaper spectral phase optimization is performed manually, awaiting the development of an automated algorithm, resulting in residual spectral phase errors. Lastly, like any coherent-combined laser systems, spatial and temporal misalignments play detrimental roles but could be minimized with further system optimization.

FIG. 5B also includes the autocorrelation traces of the pulses 551, 552 and 553 from the channels 311, 312 and 313 after pulse shaping and compression, measured at 146 fs, 185 fs and 280 fs (FWHM) respectively, corresponding to FWHM pulse durations of 106 fs, 135 fs and 205 fs. The autocorrelation trace of the shaped pulse 551 from the channel 1 311 after compression, the autocorrelation trace of the shaped pulse 552 from the channel 2 312 after compression, and the autocorrelation trace of the shaped pulse 553 from the channel 3 313 after compression are illustrated in FIG. 5B. Thus, the combined and compressed pulse 550 (42 fs) is significantly shorter than the pulses from each spectral fiber channel after compression, and is close to the transform limit (38 fs) for the measured combined spectrum. The deconvolution factors for each spectral channel are calculated separately, based on each channel's spectrum.

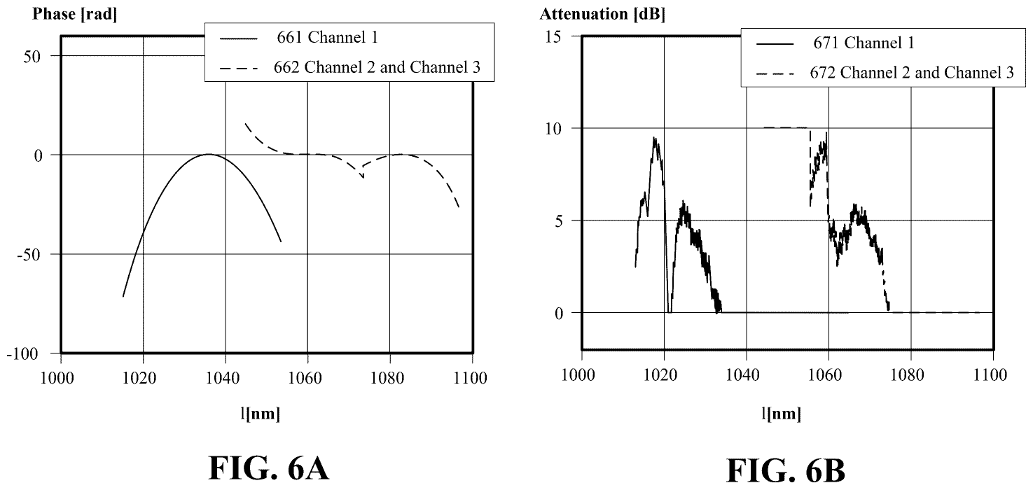

FIG. 6A illustrates an example of spectral phase profiles of the pulse shapers 301, 302 in the laser system 300 according to some embodiments. Programmable pulse shapers 301, 302 may apply spectral phases at various orders to the three spectral channels 311, 312 and 313, for achieving a combined and compressed pulse duration that is close to the transform limit. To optimally compensate for spectral phase errors in the system, the spectral phase profiles of the pulse shapers 301, 302 are first tuned until the duration of the compressed pulse from each spectral channel is minimized individually, after which the spectral phase values are re-optimized to minimize the final combined and compressed pulse duration. Optimization of spectral phases is performed by programming the pulse shapers 301, 302 to change the coefficients of different orders of spectral phases (up to fifth-order dispersion) sequentially and in iterations while diagnosing the compressed individual and combined pulses with the autocorrelator 315. As an example, optimized spectral phase profiles 661, 662 that are programmed to the pulse shapers 301, 302 in the channel 1 311, the channel 2 312 and the channel 3 313 respectively, for a shortest combined and compressed pulse are shown in FIG. 6A.

FIG. 6B illustrates an example of spectral attenuation profiles of the pulse shapers in the laser system 300 according to some embodiments. An automatic algorithm is implemented to configure the spectral attenuation profiles needed by the pulse shapers 301, 302. Referring to FIG. 6B, the attenuation profiles 671, 672 are implemented in the channel 1 311, the channel 2 312 and the channel 3 313 respectively, by the two pulse shapers 301, 302. Due to the lower power of the channel 3 313 and the spectral gap at about 1035-1052 nm from the nonlinear broadening process (not optimized) in this example, the spectral attenuation is set to be constant values in these wavelength ranges. In some examples, with optimized front-end broadband seed source and efficient long-wavelength amplifiers operating in deep saturation regimes, the spectra at each combiner leakage port (overlapping spectral region) from the respective two spectral channels may be shaped to the same shape and intensity, so that the combiner leakage power may be minimized to a negligible level via destructive interference, and the spectral combining efficiency may be maximized.

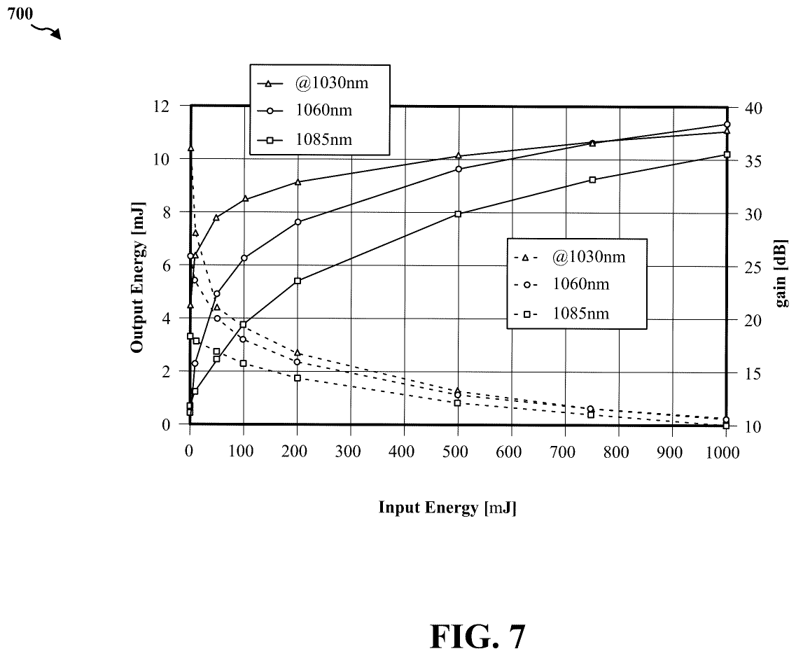

FIG. 7 illustrates an example of simulation of output energy and gain for different wavelengths, e.g., in a 1.9 m Yb-doped CCC fiber with 118 W pump power at 976 nm and an 81 ns pulse burst signal, according to some embodiments. In some examples, in a high energy, tens-of-fs system, how to divide the broad Yb: fiber gain spectrum and assign pulse shapers, including the number of spectral channels and corresponding spectral ranges may be determined by the amount of spectral intensity and phase compensation needed and optimized stretched pulse duration for energy extraction in each spectral channel. Coherently synthesized pulse shapers distributed in multiple spectral-combining channels result in less bandwidth that each pulse shaper needs to cover, as well as reduced gain narrowing and high order dispersion compensation needed in each spectral channel. For example, in high energy systems, >55 dB spectral intensity shaping might be needed even within 15 nm wavelength range (e.g. 1030-1045 nm). While the limited dynamic ranges for spectral attenuation in programmable pulse shapers (usually <30 dB) can be mitigated by adding properly designed passive filters, more than three spectral channels over the broad Yb: fiber gain spectrum might be needed, with properly located wavelength ranges. Note that the pre-amplification spectral intensity shaping in system front end does not limit overall laser system efficiency. The wavelength ranges of spectral channels also need to be apportioned so that the stretched chirped pulses are about equal duration in each channel for optimal energy extraction. For example, in the design of a 200 mJ, 40 fs FCPA combination system, the three spectral channels are 1015-1052, 1052-1077, and 1077-1095 nm, for ˜800 ps stretched pulse duration for each spectral channel.

Referring to FIG. 7, while amplification of long-wavelength spectrum (e.g. 1077-1095 nm) becomes difficult due to low stimulated gain cross sections, near complete energy extraction in the final amplifiers is possible when operating in strong saturation regimes. For example, FIG. 7 shows a simulation of gain and output energy versus input energy at different wavelengths in an 85 μm core-size Yb-doped chirally-coupled core (CCC) fiber amplifier. This simulation is using a 1.9 m Yb-doped CCC fiber with 118 W pump power at 976 nm, and an 81 ns pulse burst signal consisting of 81 chirped pulses (900 ps full pulse duration), which can potentially be stacked to one high energy pulse. At strong saturation, similar gain and output energy are achievable for long wavelength spectral channels, allowing for high extraction efficiency in final amplifier stages, although overall more amplification stages might be needed for long wavelength spectral channels.

Referring back to FIG. 3A, ultra-broadband spectral combining of ultrashort pulses from Yb-doped fiber amplifiers, with coherently-spectrally synthesized pulse shaping, is provided to achieve tens-of-fs pulses. By spectrally synthesizing three chirped-pulse fiber amplifiers and two programmable pulse shapers 301, 302 across an 80 nm overall bandwidth, ultrashort pulses with a pulse duration of 42 fs are generated. The three fiber channels 311, 312, 313 operate at different but partially overlapped wavelength ranges, and their spectral intensity and phase control are synthesized via phase synchronization in the overlapped spectral ranges. Coherently synthesized pulse shapers distributed in multiple spectral-combining channels result in less bandwidth that each pulse shaper needs to cover, as well as reduced gain narrowing and high order dispersion compensation needed in each spectral channel, thus can fully compensate for gain narrowing and high order dispersion over the broad Yb: fiber gain spectrum in high energy systems.

To the best of our knowledge, 42 fs is the shortest pulse duration achieved from a spectrally combined fiber system at one-micron wavelength. Ultra-broadband spectral combining in FCPA systems and coherently-spectrally synthesized pulse shaping, may provide high-energy, tens-of-fs FCPA systems. For example, the implementation of broadband spectral combining in spatially-temporally combined FCPA systems may provide energy-scalable, short-pulse method for demanding applications.

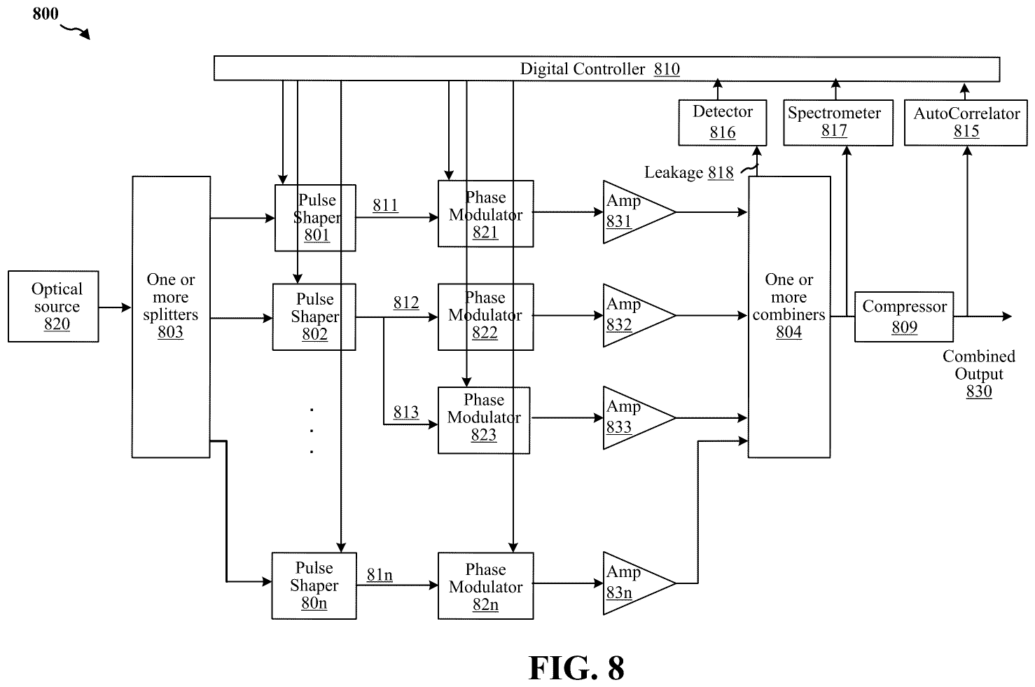

FIG. 8 illustrates a diagram of an example of a multi-channel spectrally-combined optical shaping and amplification system 800 according to some embodiments. Referring to FIG. 8, an optical source 820, e.g., a laser oscillator that generates an optical pulse, or a plurality of optical pulses, or an optical pulse train. The optical pulse may be transmitted to at least one splitter 803. The optical system 800 includes the at least one splitter 803, to split the optical pulse into a plurality of portions in a plurality of channels, e.g., a channel 811, a channel 812, a channel 813, . . . , and a channel 81n. The optical system 800 includes a plurality of pulse shapers operatively coupled with the at least one splitter 803, a pulse shaper 801, a pulse shaper 802, a pulse shaper 803, . . . , and a pulse shaper 80n. Each pulse shaper of the plurality pulse shapers is configured to shape a spectral intensity and a phase of each of at least one portion of the plurality of portions in each of at least one channel of the plurality of channels to generate at least one pulse-shaped portion of a plurality of pulse-shaped portions. For example, the pulse shaper 801 is configured to shape a spectral intensity and a phase of a portion of the optical beam in the channel 811 to generate at a pulse-shaped portion of the plurality of pulse-shaped portions. The pulse shaper 802 is configured to shape a spectral intensity and a phase of each of two portions of the optical beam in two channels, the channel 812 and the channel 813, to generate two pulse-shaped portions of the plurality of pulse-shaped portions. Each of the plurality of pulse shapers may be configured to shape one or more portions of the plurality of portions in one or more channels of the plurality of channels to generate one or more portions of the plurality of pulse-shaped portions. The optical system 800 further includes at least one combiner 804 to spectrally recombine the plurality of pulse-shaped portions in the plurality of channels (811, 812, 813, . . . , and 81n) to generate the spectrally-combined optical pulse 830.

In some examples, two pulse shapers of the plurality of pulse shapers may operate at partially-overlapped spectrum in two channels. Bandwidths of the two channels overlap in a range from 0.5 nm to 10 nm. As an example, the bandwidths of the two channels overlap about 1 nm. The optical system 800 may include a digital controller 810 to phase-synchronize the plurality of pulse-shaped portions, including phase-synchronizing the plurality of pulse-shaped portions at overlapped spectra.

By spectrally synthesizing the plurality of channels and the plurality of programmable pulse shapers operating at different but partially-overlapped spectra to cover all the plurality of spectral channels, the optical system 800 is configured to generate ultrashort pulses. The plurality of channels 811, 812, 813, . . . , operate at different but partially overlapped wavelength ranges, and their spectral intensity and phase control are synthesized via phase synchronization in the overlapped spectral ranges. The at least one splitter 803 and the at least one combiner 804 may include at least one dichroic mirror, which may be chosen to have a transition edge in a range from 0.5 nm to 10 nm, e.g., a few nm, so that the overlapped spectra at the leakage ports of the at least one combiner 804 can be diagnosed or detected for phase synchronization of the spectral channels, while maintaining low spectral combining loss.

The optical system 800 may further include a plurality of phase modulators 821, 822, 823, . . . , 82n, operatively coupled with the plurality of pulse shapers 801, 802, 803, . . . , 80n, in the plurality of channels 811, 812, 813, . . . , 81n. The plurality of phase modulators 821, 822, 823, . . . , 82n may be configured to receive one or more signals, via one or more detectors 816 and one digital controller 810, from one or more phase synchronization feedback loops and compensate one or more phase differences among the plurality of channels.

The optical system 800 may further include the one or more phase synchronization feedback loops configured to diagnose or detect one or more leakage signals 818 from the at least one combiner 804 and phase-synchronize the plurality of channels at overlapped spectral regions, e.g., with the SPGD algorithm.

The optical system 800 may further include a plurality of amplifiers 831, 832, 833, . . . , or 83n). Each spectral channel (811, 812, 813, . . . , or 81n) may incorporates an amplifier (831, 832, 833, . . . , or 83n). The channel 811 may incorporate the amplifier 831, the channel 812 may incorporate the amplifier 832; the channel 813 may incorporate the amplifier 833, . . . , and so on. In this way, the plurality of pulse-shaped and amplified spectra are generated in the plurality of channels. Afterwards, the at least one combiner 804 recombines the plurality of pulse-shaped and amplified spectra from the plurality of channels. The combined pulse may be compressed by a grating compressor 809 and diagnosed or detected by an autocorrelator 815. The autocorrelator 815 may be replaced by another temporal pulse diagnostic device.

The optical system 800 may further include a pulse-shaping feedback system which diagnoses or detects the combined spectrum, via a spectrometer 817, and the autocorrelation signal (or signal from another temporal pulse diagnostic device) of the combined and compressed pulse and sends control signals to the plurality of pulse shapers accordingly. This is to compensate for spectral intensity distortions from amplification, and for various orders of residual spectral phase at the system output, thus yielding a distortion-free combined spectrum and near transform-limited compressed pulse width.

Ultra-broadband spectral combining in FCPA systems and coherently-spectrally synthesized pulse shaping, provides a high-energy, tens-of-fs FCPA system. For example, the spectrally-combined optical pulse 830 could achieve a pulse duration as short as few tens of fs and could be scale to high pulse energy, which would be not possible without spectral combining and synthesized pulse shaping.

In some examples, how to divide the broad Yb: fiber gain spectrum and assign the plurality of pulse shapers, including the number of spectral channels and corresponding spectral ranges may be determined by the range and resolution of spectral intensity and phase compensation needed and optimized stretched pulse duration for energy extraction in each spectral channel.

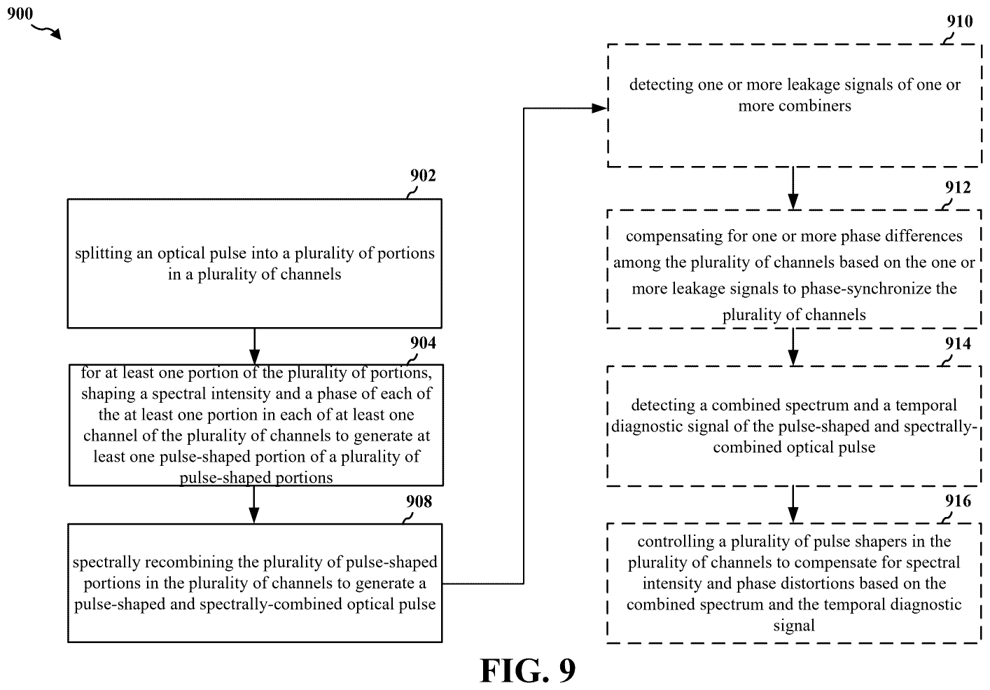

FIG. 9 illustrates a flow diagram of a method 900 of generating a pulse-shaped and spectrally-combined optical pulse according to some embodiments. With reference to FIG. 9, method 900 illustrates example functions used by various embodiments. Although specific function blocks (“blocks”) are disclosed in method 900, such blocks are examples. That is, embodiments are well suited to performing various other blocks or variations of the blocks recited in method 900. It is appreciated that the blocks in method 900 may be performed in an order different than presented, and that not all of the blocks in method 900 may be performed.

Referring to FIG. 9, the method includes spectrally splitting an optical pulse into a plurality of portions in a plurality of channels, as illustrated in block 902. The method includes that, for at least one portion of the plurality of portions, shaping a spectral intensity and a spectral phase of each of the at least one portion in each of at least one channel of the plurality of channels to generate at least one pulse-shaped portion of a plurality of pulse-shaped portions, as illustrated in block 904.

The method includes that spectrally recombining the plurality of pulse-shaped portions in the plurality of channels to generate the spectrally-combined optical pulse, as illustrated in block 908. The method may further include detecting one or more leakage signals of one or more combiners, as illustrated in block 910. The method may further include compensating for one or more phase differences among the plurality of channels based on the one or more leakage signals to phase-synchronize the plurality of pulse-shaped channels, as illustrated in block 912. The method may further include detecting a combined spectrum and a temporal diagnostic signal of the spectrally-combined optical pulse, as illustrated in block 914. The method may further include controlling a plurality of pulse shapers in the plurality of channels to compensate for spectral intensity and phase distortions based on the combined spectrum and the temporal diagnostic signal, as illustrated in block 916.

Unless specifically stated otherwise, terms such as “receiving,” “accumulating,” “performing,” “generating,” “acquiring,” “selecting,” “configurating,” determining, “inserting,” “storing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
spectrally splitting an optical pulse into a plurality of portions in a plurality of channels;
for at least one portion of the plurality of portions, shaping a spectral intensity and a spectral phase of each of the at least one portion in each of at least one channel of the plurality of channels to generate at least one pulse-shaped portion of a plurality of pulse-shaped portions; and
spectrally recombining the plurality of pulse-shaped portions in the plurality of channels to generate a pulse-shaped and spectrally-combined optical pulse.

2. The method of claim 1, wherein two portions of the plurality of portions in two channels have partially-overlapped spectra.

3. The method of claim 2, wherein bandwidths of the two channels overlap in a range from 0.5 nm to 10 nm.

4. The method of claim 1, wherein the shaping the spectral intensity and the spectral phase of each of the at least one portion in each of the at least one channel to generate the at least one pulse-shaped portion comprises:
shaping a spectral intensity and a spectral phase of each of two portions in each of two channels of the plurality of channels to generate two pulse-shaped portions of the plurality of pulse-shaped portions.

5. The method of claim 1, wherein the shaping the spectral intensity and the spectral phase of each of the at least one portion in each of the at least one channel to generate the at least one pulse-shaped portion comprises:
shaping a spectral intensity and a spectral phase of a portion in a channel of the plurality of channels to generate a pulse-shaped portion of the plurality of pulse-shaped portions.

6. The method of claim 1, further comprising:
diagnosing or detecting one or more leakage signals of one or more combiners.

7. The method of claim 6, further comprising:
compensating for one or more phase differences among the plurality of channels based on the one or more leakage signals to phase-synchronize the plurality of channels.

8. The method of claim 1, further comprising:
phase-synchronize the plurality of channels at overlapped spectral regions based on one or more leakage signals of one or more combiners.

9. The method of claim 1, further comprising:
diagnosing or detecting a combined spectrum and a temporal diagnostic signal of the pulse-shaped and spectrally-combined optical pulse; and
controlling a plurality of pulse shapers in the plurality of channels to compensate for spectral intensity and spectral phase distortions, or to achieve the desired spectral intensity and spectral phase of the spectrally-combined optical pulse, based on the combined spectrum and the temporal diagnostic signal.

10. The method of claim 1, wherein the pulse-shaped and spectrally-combined optical pulse has a pulse duration equal to or less than 42 fs.

11. A system, comprising:
at least one splitter to spectrally split an optical pulse into a plurality of portions in a plurality of channels;
a plurality of pulse shapers operatively coupled with the plurality of channels, each pulse shaper of the plurality of pulse shapers to shape a spectral intensity and a spectral phase of each of at least one portion of the plurality of portions in each of at least one channel of the plurality of channels to generate at least one pulse-shaped portion of a plurality of pulse-shaped portions; and
at least one combiner to spectrally recombine the plurality of pulse-shaped portions in the plurality of channels to generate a pulse-shaped and spectrally-combined optical pulse.

12. The system of claim 11, wherein two pulse shapers of the plurality of pulse shapers operate at partially-overlapped spectra in two channels of the plurality of channels.

13. The system of claim 12, wherein bandwidths of the two channels overlap in a range from 0.5 nm to 10 nm.

14. The system of claim 11, wherein a pulse shaper of the plurality of pulse shapers is to shape a spectral intensity and a spectral phase of each of two portions of the plurality of portions in each of two channels of the plurality of channels to generate two pulse-shaped portions of the plurality of pulse-shaped portions.

15. The system of claim 11, wherein a pulse shaper of the plurality of pulse shapers is to shape a spectral intensity and a spectral phase of a portion of the plurality of portions in a channel of the plurality of channels to generate a pulse-shaped portion of the plurality of pulse-shaped portions.

16. The system of claim 11, further comprising:
a phase synchronization feedback loop to detect at least one leakage signal of the at least one combiner and phase-synchronize the plurality of channels at overlapped spectral regions based on the at least one leakage signal.

17. The system of claim 11, further comprising:
a plurality of phase modulators operatively coupled with the plurality of pulse shapers in the plurality of channels, the plurality of phase modulators to compensate for one or more phase differences among the plurality of channels to phase-synchronize the plurality of channels.

18. The system of claim 11, further comprising:
a pulse-shaping feedback system to:
detect a combined spectrum and a temporal diagnostic signal of the pulse-shaped and spectrally-combined optical pulse.

19. The system of claim 11, wherein the pulse-shaping feedback system is further to: send control signals to the plurality of pulse shapers in the plurality of channels to compensate for spectral intensity and spectral phase distortions, or to achieve the desired spectral intensity and spectral phase of the pulse-shaped and spectrally-combined optical pulse, based on the combined spectrum and the temporal diagnostic signal.

20. The system of claim 11, wherein the pulse-shaped and spectrally-combined optical pulse has a pulse duration equal to or less than 42 fs.
